(19) United States
(12) Patent Application Publication
(10) Pub. No.: US 2017/0094219 A1
(43) Pub. Date: Mar. 30, 2017

(54) METHOD AND ELECTRONIC DEVICE FOR PROVIDING VIDEO OF A SPECIFIED PLAYBACK TIME

(71) Applicant: Samsung Electronics Co., Ltd., Gyeonggi-do (KR)

(72) Inventors: Byung Hwan KIM, Busan (KR); Eun Yeung LEE, Gyeongsangbuk-do (KR)

(73) Assignee: Samsung Electronics Co., Ltd.

(21) Appl. No.: 15/271,553

(22) Filed: Sep. 21, 2016

(30) Foreign Application Priority Data
Sep. 24, 2015 (KR) 10-2015-0135291

(51) Int. Cl. H04N 5/775; G11B 27/30

(52) U.S. Cl. CPC H04N 5/7755; G11B 27/30

(57) ABSTRACT

Disclosed is an electronic device including a display, a memory that stores a video file which includes video data and metadata, and a processor operatively connected with the display and the memory. The metadata includes information about a specified playback time point or a specified playback time interval among a total playback time of the video data. The memory stores instructions that, when executed, cause the processor to output, on the display, a first preview associated with the total playback time of the video data and a second preview associated with the specified playback time point or the specified playback time interval.

### PRIORITY

This application claims priority under 35 U.S.C. §119 (a) to a Korean Patent Application filed in the Korean Intellectual Property Office on Sep. 24, 2015 and assigned Ser. No. 10-2015-0135291, the contents of which are incorporated herein by reference.

### BACKGROUND

1. Field of the Disclosure

The present disclosure relates generally to an electronic device, and more particularly, to a video providing method of an electronic device which is capable of providing a bookmark function for specifying a video playback time.

2. Description of the Related Art

With the recent developments of integrated technology (IT), an electronic device is portable and is able to freely connect to wired/wireless networks. For example, portable electronic devices such as a smartphone or a tablet personal computer (PC) are able to support various functions, such as network connection and playback of multimedia content, in addition to a call function and a message sending/receiving function.

For example, the electronic device plays video content by using a multimedia player program and the played video content is able to be output through a display and/or an audio module embedded in or operatively connected to the electronic device.

During viewing of the video content, a user may separately want to set a certain playback time point or a playback time interval, such as when a favorable scene of the video content is played back, and may watch the video content from the specified playback time point or the specified playback time interval later or repeatedly.

To this end, the electronic device may generate information associated with the playback time point and the playback time interval specified by the user as a separate file (hereinafter “bookmark”). However, in this case, since a separate bookmark file is generated whenever the user specifies the playback time point or the playback time interval, computing/storage resources of the electronic device may be excessively consumed.

Furthermore, even in a user experience (UX), the user may only realize the presence or absence of the bookmark file when the user reproduces video content. Accordingly, when the user does not reproduce the video content, it is difficult to recognize the presence or absence of the bookmark file. As such, there is a need in the art for providing a bookmark function for specifying a video playback time of the video content.

### SUMMARY

Aspects of the present disclosure are to address at least the above-mentioned problems and/or disadvantages and to provide at least the advantages described below. Accordingly, an aspect of the present disclosure is to provide a method for allowing the user to specify and set a certain playback time point or a playback time interval of multimedia content without generating a separate bookmark file and a method for easily recognizing the bookmark.

In accordance with an aspect of the present disclosure, an electronic device includes a display, a memory that stores a video file which comprises video data and metadata, and a processor operatively connected with the display and the memory, wherein the metadata comprises information about a specified playback time point or a specified playback time interval among a total playback time of the video data, and wherein, the memory stores instructions that, when executed, cause the processor to output, on the display, a first preview associated with the total playback time of the video data and a second preview associated with the specified playback time point or the specified playback time interval.

In accordance with another aspect of the present disclosure, a video providing method of an electronic device in which a video file comprising video data and metadata is stored includes outputting, on a display, a first preview associated with a total playback time of the video data, and outputting, on the display, a second preview associated with a specified playback time point or a specified playback time interval of the video data, wherein the metadata comprises information about the specified playback time point or the specified playback time interval.

In accordance with another aspect of the present disclosure, an electronic device includes a memory that stores media data, and a processor that plays the media data through a display operatively connected with the electronic device, obtains an input while the media data is played, generates bookmark information corresponding to at least a portion of the media data based at least on the input, and includes the bookmark information in the media data.

### BRIEF DESCRIPTION OF THE DRAWINGS

The above and other aspects, features, and advantages of certain embodiments of this disclosure will be more apparent from the following description taken in conjunction with the accompanying drawings, in which:

FIG. 1 illustrates a block diagram of an electronic device according to an embodiment of the present disclosure;

FIG. 2 illustrates a video file according to an embodiment of the present disclosure;

FIG. 3 illustrates a bookmark setting method according to an embodiment of the present disclosure;

FIGS. 4A, 4B, 4C and 4D illustrate a bookmark setting method according to an embodiment of the present disclosure;

FIG. 5 illustrates a video preview providing method according to an embodiment of the present disclosure;

FIG. 6 illustrates an electronic device to which a video preview according to an embodiment of the present disclosure is provided;

FIG. 7 illustrates a video sharing method based on a bookmark preview, according to an embodiment of the present disclosure;

FIG. 8 illustrates an electronic device in a network environment, according to embodiments of the present disclosure;

FIG. 9 illustrates a block diagram of an electronic device according to embodiments of the present disclosure; and

FIG. 10 illustrates a block diagram of a program module according to embodiments of the present disclosure.

Throughout the drawings, it should be noted that like reference numbers are used to depict the same or similar elements, features, and structures.

### DETAILED DESCRIPTION OF EMBODIMENTS OF THE DISCLOSURE

Embodiments of the present disclosure may be described with reference to accompanying drawings. Accordingly, those of ordinary skill in the art will recognize that modification, equivalent, and/or alternative on the embodiments described herein can be variously made without departing from the scope and spirit of the present disclosure. With regard to description of drawings, similar elements may be marked by similar reference numerals.

The expressions “have”, “may have”, “include” and “comprise”, or “may include” and “may comprise” used herein indicate existence of corresponding features (e.g., elements such as numeric values, functions, operations, or components) but do not exclude presence of additional features.

The expressions “A or B”, “at least one of A or/and B”, or “one or more of A or/and B” used herein may include any and all combinations of one or more of the associated listed items. For example, the expression “A or B”, “at least one of A and B”, or “at least one of A or B” may refer to all of (1) where at least one A is included, (2) where at least one B is included, or (3) where both of at least one A and at least one B are included.

Recitations such as “first” or “second” used herein may refer to various elements of embodiments of this disclosure, but do not limit the elements. For example, “a first user device” and “a second user device” may indicate different user devices regardless of the order or priority thereof. For example, without departing the scope of this disclosure, a first element may be referred to as a second element, and similarly, a second element may be referred to as a first element.

It will be understood that when an element, such as a first element, is referred to as being “operatively or communicatively coupled with/to” or “connected to” another element, such as a second element, it may be directly coupled with/to or connected to the other element or an intervening element, such as a third element, may be present. In contrast, when the first element is referred to as being “directly coupled with/to” or “directly connected to” the second element, it should be understood that there is no intervening third element.

According to the situation, the expression “configured to” used herein may be used interchangeably with the expressions “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. CPU a “processor configured to perform A, B, and C” may mean a dedicated processor (e.g., an embedded processor) for performing a corresponding operation or a generic-purpose processor (e.g., a central processing unit (CPU) or an application processor) which may perform corresponding operations by executing one or more software programs which are stored in a memory device.

Terms used in this disclosure are used to describe specified embodiments and are not intended to limit the scope of the present disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in embodiments of the present disclosure. In some cases, even if terms are defined in this disclosure, they may not be interpreted to exclude embodiments of the present disclosure.

For example, an electronic device according to embodiments of the present disclosure may include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), motion picture experts group (MPEG-1 or MPEG-2) audio layer 3 (MP3) players, mobile medical devices, cameras, or wearable devices. A wearable device may include at least one of an accessory type of a device (e.g., a timepiece, a ring, a bracelet, an anklet, a necklace, glasses, a contact lens, or a head-mounted-device (HMD)), one-piece fabric or clothes type of a device (e.g., electronic clothes), a body-attached type of a device (e.g., a skin pad or a tattoo), or a bio-implantable type of a device (e.g., implantable circuit).

According to another embodiment, the electronic devices may be home appliances including at least one of televisions (TVs), digital versatile disc (DVD) players, audio players, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ or PlayStation™), electronic dictionaries, electronic keys, camcorders, or electronic picture frames.

According to another embodiment, the photographing apparatus may include at least one of medical devices (e.g., various portable medical measurement devices such as a blood glucose monitoring device, a heartbeat measuring device, a blood pressure measuring device, and a body temperature measuring device), a magnetic resonance angiography (MRA), a magnetic resonance imaging (MRI), a computed tomography (CT), scanners, and ultrasonic devices), navigation devices, global positioning system (GPS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller machines (ATMs), points of sales (POSs) terminals, or Internet of Things (IoT) devices (e.g., light bulbs, various sensors, electric or gas meters, sprinkler devices, fire alarms, thermostats, street lamps, toasters, exercise equipment, hot water tanks, heaters, and boilers).

According to another embodiment, the electronic devices may include at least one of parts of furniture or buildings/structures, electronic boards, electronic signature receiving devices, projectors, or various measuring instruments (e.g., water meters, electricity meters, gas meters, or wave meters). In the embodiments, the electronic device may be one of the above-described various devices or a combination thereof.

An electronic device according to an embodiment may be a flexible device, and may not be limited to the above-described electronic devices and may include other electronic devices and new electronic devices according to developments of technology.

Hereinafter, an electronic device according to embodiments may be described with reference to the accompanying drawings. The term “user” used herein may refer to a person who uses an electronic device or may refer to an artificial intelligence electronic device that uses an electronic device.

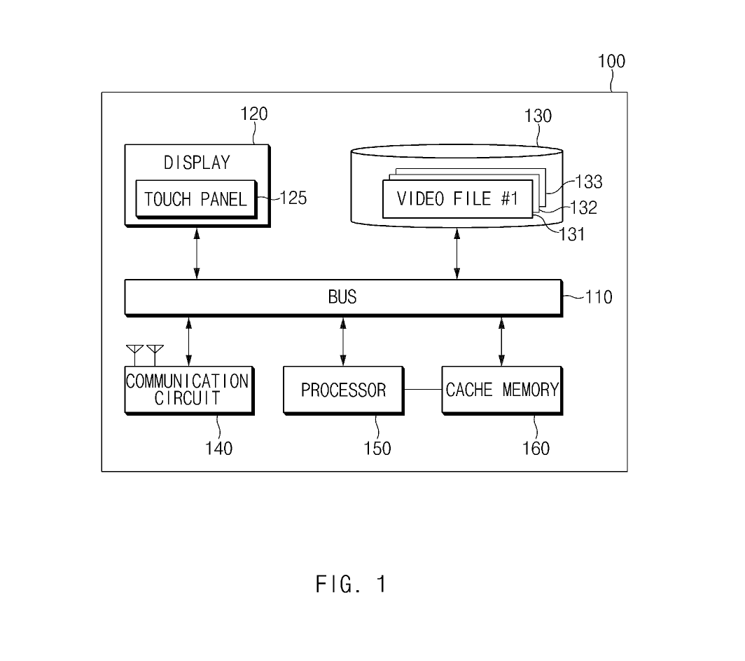

FIG. 1 illustrates a block diagram of an electronic device according to an embodiment of the present disclosure.

Referring to FIG. 1, an electronic device 100 according to an embodiment of this disclosure may include a bus 110, a display 120, a memory 130, a communication circuit 140, a processor 150, and a cache memory 160The electronic device 100 may not include at least one of the above-described elements or may further include any other element(s).

The bus 110 may interconnect the above-described elements 120 to 160 and may be a circuit for conveying communications (e.g., a control message and/or data) among the above-described elements.

The display 120 may output various content (e.g., a text, an image, a video, an icon, or a symbol) to a user. To this end, the display 120 may include a panel or a display driving circuit. According to embodiments, the display 120 may sense a touch or a touch gesture from the user. To this end, the display 120 may further include a touch panel 125. Various user interfaces (UIs) which are usable in embodiments of the present disclosure may be provided to the user through the display 120 and the touch panel 125.

The memory 130 may include a volatile and/or nonvolatile memory. The memory 130 may store various instructions, when executed, causing the processor 150 to perform an operation in response to the various instructions, as will be described later herein.

The memory 130 may store at least one video file 131, 132, or 133. In this disclosure, embodiments will be described on the basis of a video file. However, embodiments of this disclosure may not be limited thereto. For example, a file to which embodiments of this disclosure are applicable may include a media data file such as an image, audio, or text file.

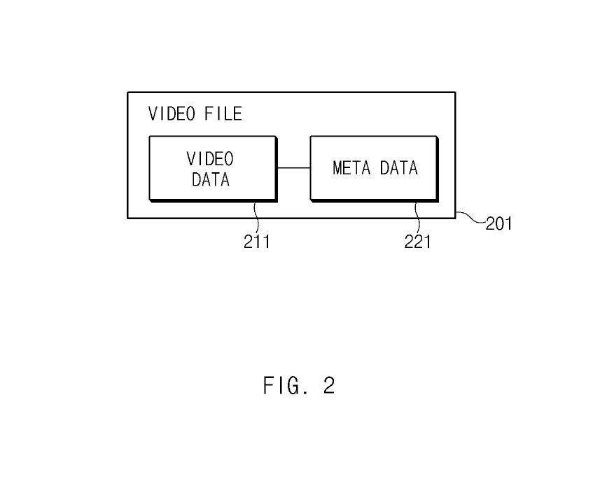

FIG. 2 illustrates a video file according to an embodiment of the present disclosure.

Referring to FIG. 2, a video file 201 may include video data 211 and metadata 221. The video file 201 may correspond to any one of the video files 131 to 133.

The video data 211 may include a plurality of image data based on a number of frames and/or a plurality of audio data respectively corresponding to the plurality of image data. The video data 211 may be encoded according to a specified codec.

The metadata 221 may indicate information about properties of the video data 211. For example, the metadata 221 may include a variety of information about the video data 211 (or the video file 201), such as a title, a sub-title, a total playback time (or duration), a file generation time, resolution, an artist name, genre, and a used language.

According to an embodiment, the metadata 221 may further include bookmark information about a playback time point or a playback time interval specified by a user. That is, the bookmark information may not be generated as a separate file, but it may be included in the metadata 221 of the video file 201. Furthermore, the specified playback time point or playback time interval may be used as a preset playback time point or a bookmarked playback time point. According to embodiments, bookmark information may further include information about a playback speed set by a user in addition to the above-described information. When a video is played on the basis of the bookmark information, the playback speed information may be applied to the playback of the video.

Returning to FIG. 1, the communication circuit 140 may establish a communication with an external device based on a specified protocol. The electronic device 100 may send and receive data or a file through the communication circuit 140.

The processor 150 may be electrically connected with the display 120, the memory 130, the communication circuit 140, and the cache memory 160 of the electronic device 100. In addition to methods to be described below, the processor 150 may control the elements of the electronic device 100 or may perform various operations such as an operation associated with communication and a data processing operation.

According to an embodiment, the processor 150 may be configured to output a first preview (e.g., a preview video corresponding to an original video file, or an “original preview”) associated with video data of the original video file on the display 120. That is, the original preview may correspond to a preview associated with a total playback time of the video data of the original video file.

Furthermore, according to another embodiment, the processor 150 may be configured to output a second preview (e.g., a preview video corresponding to bookmark information, or a “bookmark preview”) based on metadata of the video file on the display 120. For example, the second preview may correspond to a preview associated with a bookmarked playback time point or a bookmarked playback time interval of the video data.

The original preview and/or the second preview may be an object that is capable of being generated by the processor 150 and is capable of being output on the display 120. For example, whenever the processor 150 searches for a video file from the memory 130, the processor 150 may generate the original preview and/or the second preview and may output the original preview and/or the second preview on the display 120. In this case, the processor 150 may store data associated with the original preview and/or the second preview in the cache memory 160 that is a high-speed volatile memory.

According to an embodiment, the original preview and/or the bookmark preview may include an image object (e.g., a thumbnail image object) or a video object (e.g., a thumbnail video object). In this disclosure, the image object may be referred to as a first-type object and the video object may be referred to as a second-type object.

The image object or the video object of the original preview may be extracted from at least a portion of a total playback time of video data. For example, the image object of the original preview may correspond to an object, which is based on a first frame image or a specified frame image of the video data. The video object of the original preview may be an object corresponding to a specified playback time interval (e.g., three seconds from a first frame of video data) of the video data or may correspond to an object sampled from frame images of the specified playback time interval.

The image object or the video object of the bookmark preview may be extracted from the bookmarked playback time point of the video data or from at least a portion of the bookmarked playback time interval of the video data. For example, the image object of the second preview may be based on a frame image of the bookmarked playback time point or a frame image of the starting time point of the bookmarked playback time interval. The video object of the second preview may be extracted from a specified playback time interval starting from the bookmarked playback time point or from a portion of the bookmarked playback time interval.

According to embodiments, the processor 150 may play video data of a video file stored in the memory 130 by using a multimedia player program. The video data of the played video file may be output on the display 120.

For example, if the original preview is selected according to a user input (e.g., a touch input received through the touch panel 125), the processor 150 may play video data from a predefined playback time point. In other words, if a first preview associated with video data of an original video file is selected, the processor 150 may play the video data of the original video file from the predefined playback time point with regard to a total playback time. The predefined playback time point may include a first playback time point of the video data or a playback time point at which the playback of the video data was previously ended.

If the bookmark preview is selected according to a user input, the processor 150 may play the video data of the original video file from a bookmarked playback time point or a starting time point of a bookmarked playback time interval. A starting playback time point and an implementation method when the second preview is selected may not be limited thereto.

The cache memory 160 may be operatively connected with the processor 150. According to an embodiment, the cache memory 160 may be a volatile memory and may be capable of processing data faster than the memory 130. The processor 150 may extract an object associated with the original preview and/or the second preview from the video files 131 to 133 stored in the memory 130 and may store data (e.g., data of an object included in a preview) associated with the previews in the cache memory 160. Whenever outputting a preview, the processor 150 may extract an object for the preview and may store the extracted object in a high-speed volatile memory (the cache memory 160). For this reason, the processor 150 does not need to extract the object in advance and store the extracted object in the memory 130.

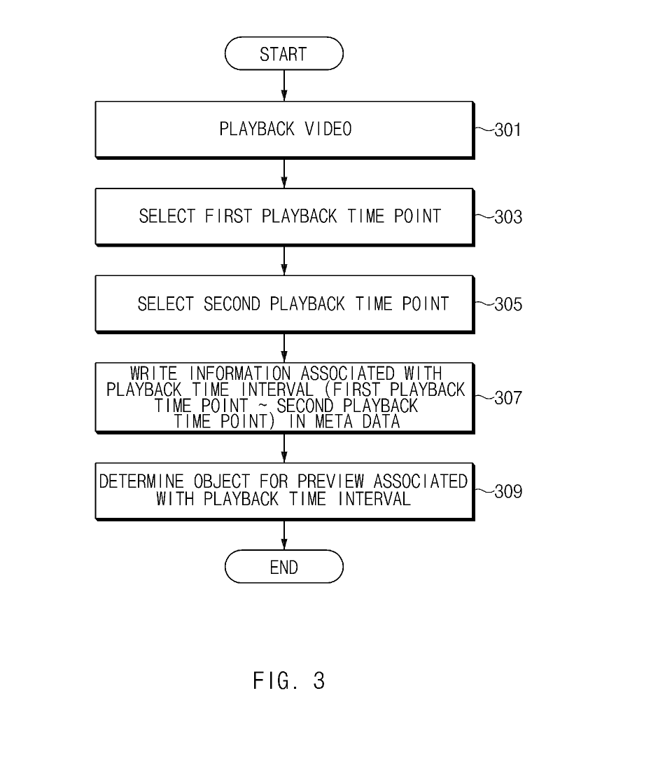

FIG. 3 illustrates a bookmark setting method according to an embodiment of the present disclosure.

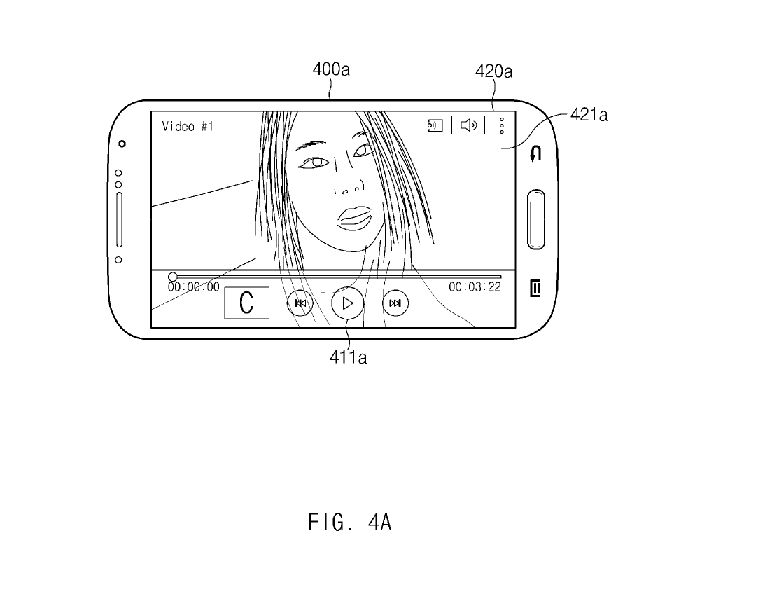

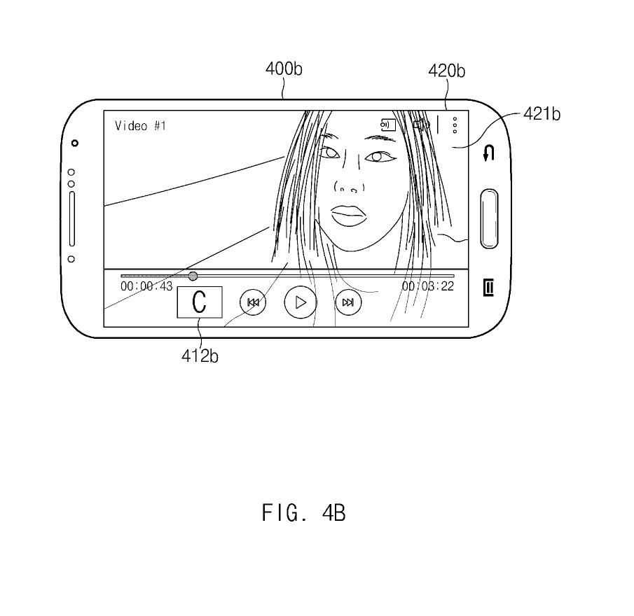

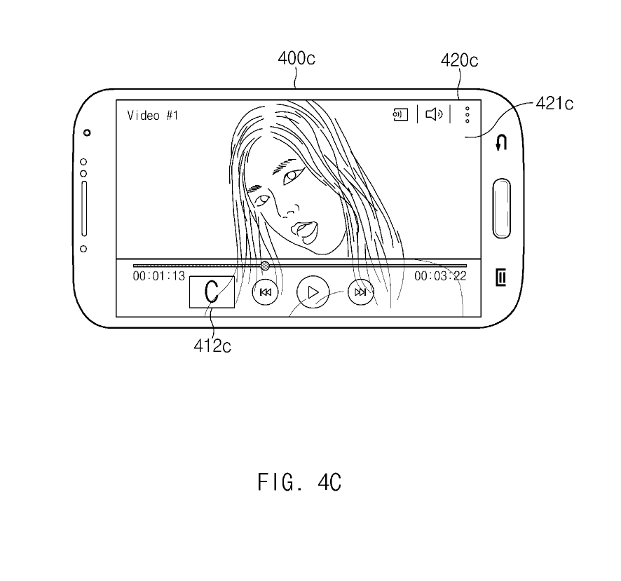

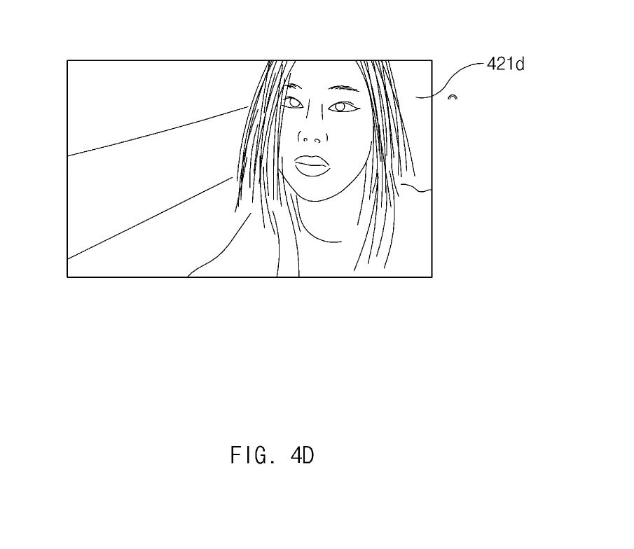

Referring to FIG. 3, a bookmark setting method will be described with reference to FIGS. 4A, 4B, 4C and 4D. In addition, since the electronic device 100 illustrated in FIG. 1 is capable of performing the operations of FIG. 3, the operations of FIG. 3 may use reference numerals of FIG. 1. Furthermore, the electronic device 100 of FIG. 1 may correspond to each of electronic devices 400a, 400b, and 400c of FIGS. 4A, 4B and 4C.

In operation 301, the electronic device 100 may play video data of a video file by executing a multimedia player application program.

FIG. 4A illustrates a bookmark setting method according to an embodiment of the present disclosure. A processor of the electronic device 400a may execute the multimedia player application program. If a preview of Video #1 (a video file) is selected according to a user input, as illustrated in FIG. 4A, predefined UI objects such as various soft keys and playback time axis, and a first frame image 421a of Video #1 may be output on a display 420a of the electronic device 400a. The electronic device 400a may receive a user input with respect to a playback button object 411a among the specified UI objects and may play video data of Video #1.

In operation 303 of FIG. 3, a user may select a first playback time point for a bookmark by using a UI object output on the display 120 of the electronic device 100 while video data of a video file is played.

Referring to FIG. 4B, a processor of the electronic device 400b may play the video data of Video #1. For example, a display 420b of the electronic device 400b may be outputting a frame image 421b at “00:00:43”. For example, when the playback time point of Video #1 is “00:00:43”, the user may select a bookmark button object 412b output on the display 420b. The processor of the electronic device 400b may recognize the playback time point at which the bookmark button object 412b is selected, that is, “00:00:43”, as a starting time point of a bookmark playback time interval (a first playback time point).

In operation 305 of FIG. 3, the user may select a second playback time point for the bookmark by using a UI object output on the display 120 of the electronic device 100 while the video data of the video file is played.

Referring to FIG. 4C, a processor of the electronic device 400c may continuously play back the video data of Video #1 . For example, a display 420c of the electronic device 400c may be outputting a frame image 421c at “00:01:13”. For example, when the playback time point of Video #1 is “00:01:13”, the user may select a bookmark button object 412c output on the display 420c. The processor of the electronic device 400c may recognize the playback time point at which the bookmark button object 412c is selected, that is, “00:01:13”, as an end time point of the bookmark playback time interval (a second playback time point).

In operation 307 of FIG. 3, the processor 150 of the electronic device 100 may write information about the playback time interval, which is an interval from the first playback time point to the second playback time point, in metadata of the video file that is being played as bookmark information. For example, since “00:00:43” is selected as the first playback time point in FIG. 4B and “00:01:13” is selected as the second playback time point in FIG. 4C, the playback time interval from “00:00:43” to “00:01:13” may be bookmarked. Information about the bookmarked playback time interval may be written in the metadata as bookmark information.

In operation 309, the processor 150 of the electronic device 100 may determine an object that is to be used when a bookmark preview of the playback time interval bookmarked in operation 307 is provided. According to embodiments, operation 309 may be omitted.

For example, since “00:00:43” is selected as the first playback time point in FIG. 4B and “00:01:13” is selected as the second playback time point in FIG. 4C, the frame image 421b of the first playback time point (“00:00:43”), which is the starting time point of the bookmarked playback time interval, may be determined as an image object 421d that will be included in a bookmark preview later (refer to FIG. 4D).

According to embodiments, FIG. 3 and FIGS. 4A, 4B, 4C and 4D are described under an assumption that bookmarking is made on a playback time interval. However, bookmarking can also be made on a certain playback time point. In this case, operation 305 may be omitted.

In the bookmark setting method according to an embodiment of the present disclosure described with reference to FIGS. 3, 4A, 4B, 4C and 4D, a separate bookmark file may not be generated because information about the bookmarked playback time interval is written in metadata. Accordingly, it is possible to prevent an unnecessary waste of computing/storage resources. Furthermore, it is possible for bookmarking to be made on a playback time interval as well as any playback time point.

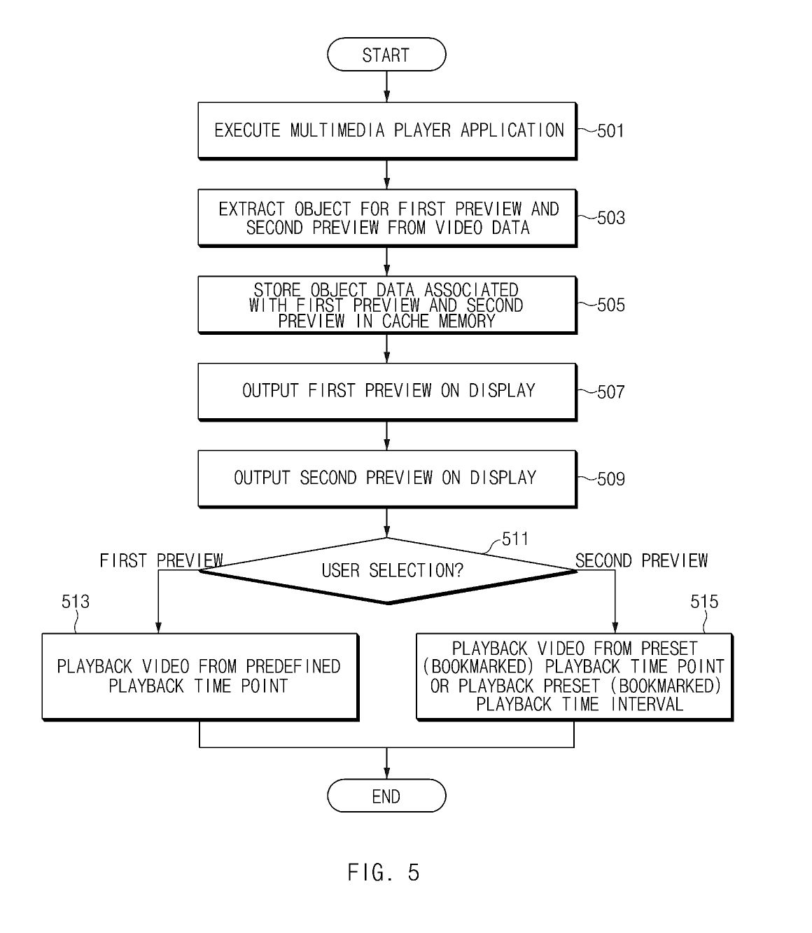

FIG. 5 illustrates a video preview providing method according to an embodiment of the present disclosure.

Referring to FIG. 5, operations 501 to 515 may be performed after operations 301 to 309 of FIG. 3 are performed (e.g., after at least one bookmark preview is generated). For example, since the electronic device 100 illustrated in FIG. 1 is capable of performing the operations of FIG. 5, the operations of FIG. 5 may use reference numerals of FIG. 1.

In operation 501, the processor 150 of the electronic device 100 may execute a multimedia player application program. If the multimedia player application program is executed, the processor 150 may search for a video file from the memory 130. For example, the processor 150 may recognize that Video #1 (a video file) and Video #2 (a video file) are stored in the memory 130.

In operation 503, the processor 150 of the electronic device 100 may extract objects for a first preview and a second preview (a bookmark preview) from video data of the video files.

For example, the processor 150 of the electronic device 100 may extract and generate an image object or a video object for the original preview from at least a portion of a total playback time of the video data of each of Video #1 and Video #2.

The processor 150 of the electronic device 100 may extract and generate an image object or a video object for the bookmark preview, based on metadata of each of Video #1 and Video #2. For example, the processor 150 may extract and generate an image object or a video object for the bookmark preview from a bookmarked playback time point or at least a portion of a bookmarked playback time interval of the video data of each of Video #1 and Video #2.

In operation 505, the processor 150 of the electronic device 100 may store data associated with the original preview and the second preview in the cache memory 160. For example, the processor 150 may store data of the object for the original preview and data of the object for the bookmark preview extracted and generated in operation 503 in the cache memory 160.

In operation 507, the processor 150 of the electronic device 100 may output the original preview associated with the total playback time of the video data on the display 120.

In operation 509, the processor 150 of the electronic device 100 may output the bookmark preview associated with the bookmarked playback time point or the bookmarked playback time interval of the video data on the display 120.

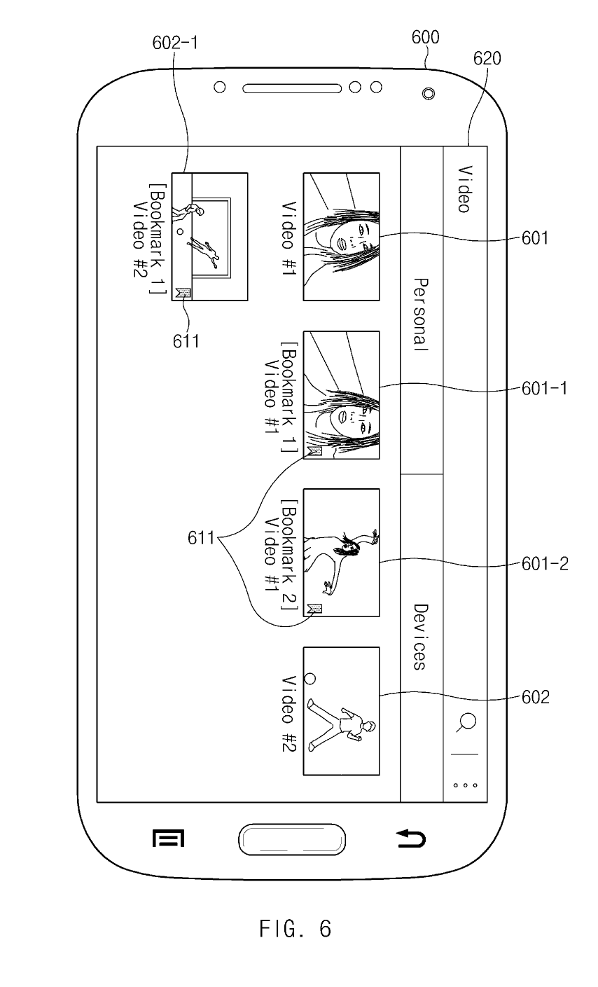

With regard to operations 507 and 509, FIG. 6 illustrates an electronic device 600 on which a video preview according to an embodiment of this disclosure is displayed. Previews of Video #1 and Video #2 stored in the memory 130 are illustrated in a display 620 of the electronic device 600.

For example, a preview 601 illustrates an original preview related to the total playback time of the video data of Video #1. A preview 602 illustrates an original preview related to the total playback time of the video data of Video #2. Each of a preview 601-1 and a preview 601-2 illustrates a second bookmark preview that is based on the metadata of Video #1. A preview 602-1 illustrates a bookmark preview that is based on the metadata of Video #2. The bookmark previews 601-1, 601-2, and 602-1 may be associated with a bookmarked playback time point or a bookmarked playback time interval. Furthermore, an indication 611 (e.g., an icon, a badge, or a border) which indicates that the bookmark previews 601-1, 601-2, and 602-1 are bookmark previews may be added to each of the bookmark previews 601-1, 601-2, and 602-1 unlike the original previews 601 and 602.

In operation 511, the electronic device 100 may receive a user input (or selection). For example, the user input (e.g., a touch input, a gesture, or a voice input received through the touch panel 125) may correspond to the selection of a first preview or a second preview output in operation 507 and operation 509. For example, in FIG. 6, the user input may correspond to the selection of one of the original previews 601 and 602 or one of the bookmark previews 601-1, 601-2, and 602-1. If the user input is for selecting the original preview 601 or 602, the process proceeds to operation 513, whereas if the user input is for selecting the second preview 601-1, 601-2, or 602-1, the process proceeds to operation 515.

Since the user input for selecting the original preview is previously received, in operation 513, the processor 150 of the electronic device 100 may play video data from a predefined playback time point. In other words, since the original preview associated with video data of an original video file is selected, the processor 150 may play the video data of the original video file from the predefined playback time point of a total playback time. The predefined playback time point may include a first playback time point of the video data or a playback time point at which the playback of the video data was previously ended.

For example, in FIG. 6, if the original preview 602 is selected, a processor of the electronic device 600 may play video data of Video #2 from a first playback time point or a previously ended playback time point.

Since the user input for selecting the bookmark preview is previously received, in operation 515, the processor 150 of the electronic device 100 may play the video data from the playback time point bookmarked by the user. Furthermore, the processor 150 may play the video data from the playback starting time point of the bookmarked playback time interval to the playback end time point of the bookmarked playback time interval.

An embodiment is illustrated in FIG. 5 as the process ends after operations 513 or 515. However, embodiments may not be limited thereto. For example, the process may return to operation 511 to perform one of operations 513 or 515.

Furthermore, in operation 511, the user may modify bookmark information or an object included in the second preview by selecting the bookmark preview output on the display 120 in a specified manner. For example, in the case of FIG. 6, the user may access metadata of the original video file by performing a touch long press action with respect to any one of the bookmark previews 601-1, 601-2, and 602-1 output on the display 620. The user may modify the bookmarked playback time point or the bookmarked playback time interval by modifying the metadata.

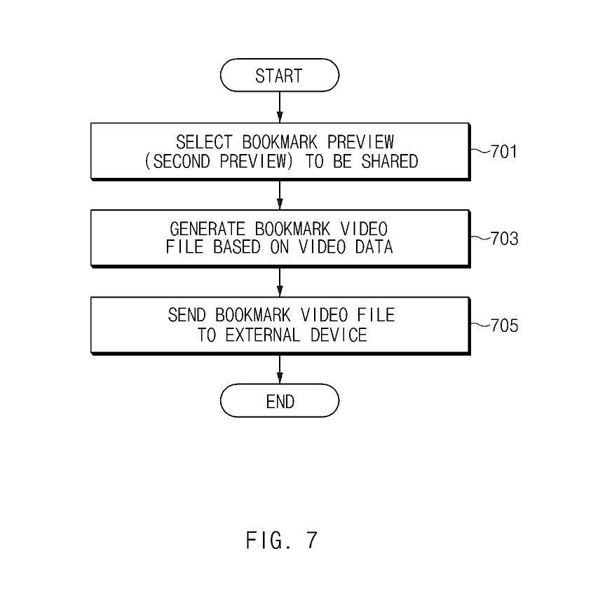

FIG. 7 illustrates a method of sharing a video based on a bookmark preview, according to an embodiment of the present disclosure.

As described above, a bookmark preview may be generated based on bookmark information included in metadata of an original video file, and an object included in the bookmark preview may be extracted from video data of the original video file whenever the bookmark preview is generated. Therefore, a separate video file associated with a bookmarked playback time point or a bookmarked playback time interval may be needed to share a video associated with the bookmark preview with an external device, since the bookmark preview itself output on a display does not include video data content.

Referring to FIG. 7, operations 701 to 705 may be performed after operations 501 to 509 of FIG. 5 are performed. In addition, since the electronic device 100 of FIG. 1 is capable of performing the operations of FIG. 7, the reference numerals of FIG. 1 are used.

In operation 701, a user may select a bookmark preview output on the display 120 of the electronic device 100. For example, in FIG. 6, the user may select a bookmark preview to be shared by using a UI that is generated by performing a touch long press action with respect to any one of the bookmark previews 601-1, 601-2, and 602-1 output on the display 120.

In operation 703, the processor 150 of the electronic device 100 may generate a video file corresponding to a bookmarked playback time interval based on an original video file associated with the bookmark preview selected in operation 701. Alternatively, on the basis of the original video file, the processor 150 may generate a bookmark video file corresponding to an interval from the bookmarked playback time point to the end time point of a total playback time.

In operation 705, the processor 150 of the electronic device 100 may send the bookmark video file generated in operation 703 to an external device.

Furthermore, according to embodiments, the external device may store a video file which is the same as the original video file stored in the electronic device 100. In this case, the electronic device 100 may extract only bookmark information corresponding to the bookmark preview from metadata of the original video file and may send the extracted bookmark information (e.g., information about the bookmarked playback time point or the bookmarked playback time interval) to the external device. For example, the external device may add the bookmark information received from the external device 100 to metadata of the original video file, which is stored in advance. As such, the external device may provide the user with a bookmark preview which is the same as the bookmark preview of the electronic device 100.

According to embodiments of the present disclosure described above, a bookmark function may be provided without generating a separate file, by applying metadata included in a video file. Accordingly, it is possible to reduce computing/storage resources consumed to generate a separate bookmark file.

Furthermore, since the bookmark preview and the original preview are displayed together so as to be distinguished from each other, even though the original video is not played, a video corresponding to a bookmark may be more conveniently played by selecting the bookmark preview. In addition, if the bookmark preview output on the display is selected using a specified UI, it may be possible to easily modify a bookmarked playback time point or a bookmarked playback time interval and to share a bookmark video file with an external device.

According to an embodiment of the present disclosure, an electronic device includes a display, a memory that stores a video file which includes video data and metadata, and a processor operatively connected with the display and the memory. The metadata includes information about a specified playback time point or a specified playback time interval of a total playback time of the video data. The memory stores instructions, when executed, causing the processor to output a first preview associated with the total playback time of the video data and a second preview associated with the specified playback time point or the specified playback time interval of the video data on the display.

According to an embodiment, if the first preview is selected, the instructions may further include an instruction which causes the processor to play the video data from a predefined playback time point.

According to an embodiment, the predefined playback time point may include a first playback time point of the video data or a playback time point at which the playback of the video data was previously ended.

According to an embodiment, if the second preview is selected, the instructions may further include an instruction which causes the processor to play the video data from the specified playback time point or a starting time point of the specified playback time interval.

According to an embodiment, the electronic device may further include a cache memory operatively connected with the processor. Data associated with the first preview or the second preview is stored in the cache memory.

According to an embodiment, the first preview or the second preview may include an image object or a video object.

According to an embodiment, the image object or the video object of the first preview may be extracted from at least a portion of the total playback time of the video data.

According to an embodiment, the image object or the video object of the second preview may be extracted from the specified playback time point of the video data or at least a portion of the specified playback time interval of the video data.

According to an embodiment, the instructions may further include an instruction which causes the processor to generate a video file corresponding to the specified playback time point or the specified playback time interval based on the video data.

According to an embodiment, the electronic device may further include a communication circuit that establishes a communication with an external device. The instructions may further include an instruction which causes the processor to send the generated video file to the external device through the communication circuit.

According to an embodiment, a video providing method of an electronic device in which a video file, which includes video data and metadata, is stored includes outputting a first preview associated with a total playback time of the video data on a display and outputting a second preview associated with a specified playback time point or a specified playback time interval of the video data on the display. The metadata includes information associated with the specified playback time point or the specified playback time interval.

According to an embodiment, the video providing method may further include playback the video data from a predefined playback time point if the first preview is selected.

According to an embodiment, the predefined playback time point may include a first playback time point of the video data or a playback time point at which the playback of the video data was previously ended.

According to an embodiment, the video providing method may further include playback the video data from the specified playback time point or a starting playback time point of the specified playback time interval if the second preview is selected.

According to an embodiment, data associated with the first preview or the second preview may be stored in a cache memory included in the electronic device.

According to an embodiment, the first preview or the second preview may include an image object or a video object.

According to an embodiment, the video providing method may further include extracting the image object or the video object for the first preview from at least a portion of the total playback time of the video data.

According to an embodiment, the video providing method may further include extracting the image object or the video object for the second preview from the specified playback time point of the video data or at least a portion of the specified playback time interval of the video data.

According to an embodiment, the video providing method may further include generating a video file corresponding to the specified playback time point or the specified playback time interval based on the video data.

According to an embodiment, the video providing method may further include sending the generated video file to an external device.

According to an embodiment, an electronic device includes a memory that stores media data and a processor. The processor is configured to play the media data through a display operatively connected with the electronic device, to obtain an input while the media data is played, to generate bookmark information corresponding to at least a portion of the media data based at least on the input, and to include the bookmark information in the media data.

According to an embodiment, the processor may be configured to include the bookmark information in the media data as at least a portion of the media data and to store the media data including the bookmark information in the memory.

According to an embodiment, the processor may be configured to output an object of at least the portion of the media data corresponding to the bookmark information on the display.

According to an embodiment, the processor may be configured to output the object corresponding to the bookmark information as a first-type object on the display by using at least a portion of at least the portion of the media data if a playback time point of at least the portion of the media data corresponding to the bookmark information belongs to a first specified range and to output the object corresponding to the bookmark information as a second-type object on the display by using at least the portion of at least the portion of the media data if the playback time point of at least the portion of the media data corresponding to the bookmark information belongs to a second specified range.

According to an embodiment, the processor may be configured to generate a preview video corresponding to at least the portion of the media data based on at least a portion of the bookmark information.

According to an embodiment, the bookmark information may include a plurality of the bookmark information, and the preview video may include a video in which a plurality of at least partial media data respectively corresponding to the plurality of bookmark information are played in a playback time sequence.

For example, in FIG. 6, if the bookmark previews 601-1 and 601-2 (examples of the second preview) are linked to each other, preview that is arranged in a time sequence based on an order of playback time points may be generated. The generated preview may be output on a display instead of the original preview 601(an example of the first preview). That is, without separately generating the original preview 601, it is possible to configure a preview object that indicates the original video file, by using the bookmark previews 601-1 and 601-2.

In another example, when bookmark #1 (an image preview of a specified playback time point), bookmark #2 (a video preview for 1˜2 seconds of a total playback time) and bookmark #3 (a video preview for 2˜3 seconds of the total playback time) exist, the electronic device may configure an object associated with the original preview by using the plurality of bookmark information without generating a preview (e.g., the original preview 601) associated with the original video file.

According to an embodiment, if the bookmark information is included in the media data, the processor may be configured to display an indication on a portion of an object corresponding to the media data.

According to an embodiment, the processor may be configured to include the bookmark information in metadata corresponding to the media data.

According to an embodiment, the processor may be configured to send media data, in which the bookmark information is included, to an external electronic device such that at least the portion of the media data is provided by the external electronic device based at least in part on the bookmark information.

According to an embodiment, at least the portion of the media data may include first media data corresponding to a first range and second media data corresponding to a second range lagging behind the first range. The bookmark information may include first bookmark information corresponding to the first media data and second bookmark information corresponding to the second media data. The processor may be configured to assign a first priority to the first bookmark information and to assign a second priority to the second bookmark information.

For example, when the electronic device plays a video associated with the bookmark information by selecting at least one bookmark preview corresponding to bookmark information, the electronic device may play the video based on a priority included in the bookmark information. For example, the electronic device may utilize the order of the playback times as a reference for setting priority.

According to an embodiment, the processor may be configured to output the second media data before the first media data on the display based at least in part on the first priority or the second priority.

According to an embodiment, the processor may be configured to display first media data corresponding to first bookmark information and second media data corresponding to second bookmark information on the display, based at least on the first bookmark information corresponding to at least the portion of the media data and the second bookmark information corresponding to at least a portion of other media data.

For example, the processor of the electronic device may classify bookmark information based on the features of the bookmarked media data (e.g., a result of analyzing whether the media data is expressed with a figure or a background as the center) with reference to bookmark information of media data which are different from each other. The features of the media data may be included in bookmark information. Besides, the features of the media data may further include information that is obtained by analyzing a central figure or central content in the bookmarked playback time.

According to an embodiment, the processor may be configured to generate the bookmark information based at least on a playback history on the media data or any other media data.

According to an embodiment, the bookmark information may include playback speed information associated with at least the portion of the media data.

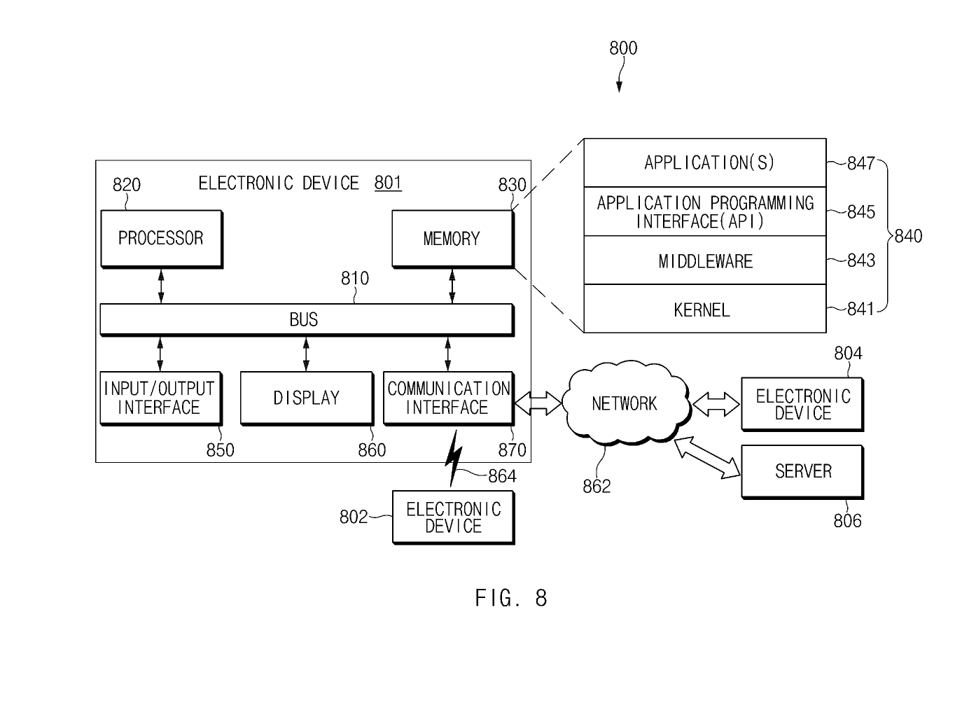

FIG. 8 illustrates an electronic device in a network environment, according to embodiments of the present disclosure.

Referring to FIG. 8, an electronic device 801, 802, or 804 and a server 806 may be connected with each other through a network 862 or a local area network 864. The electronic device 801 may include a bus 810, a processor 820, a memory 830, an input/output (I/O) interface 850, a display 860, and a communication interface 870. According to an embodiment, the electronic device 801 may not include at least one of the above-described elements or may further include other element(s).

The bus 810 may interconnect the above-described elements 810 to 870 and may be a circuit for conveying communications (e.g., a control message and/or data) among the above-described elements.

The processor 820 may include one or more of a central processing unit (CPU), an application processor (AP), or a communication processor (CP). The processor 820 may perform data processing or an operation associated with control and/or communication of at least one other element(s) of the electronic device 801.

The memory 830 may include a volatile and/or nonvolatile memory. The memory 830 may store instructions or data associated with at least one other element(s) of the electronic device 801. According to an embodiment, the memory 830 may store software and/or a program 840. The program 840 may include a kernel 841, a middleware 843, an application programming interface (API) 845, and/or applications 847. At least a portion of the kernel 841, the middleware 843, or the API 845 may be referred to as an “operating system (OS)”.

The kernel 841 may control or manage system resources (e.g., the bus 810, the processor 820, or the memory 830) that are used to execute operations or functions of other programs (e.g., the middleware 843, the API 845, and at least one of applications 847. Furthermore, the kernel 841 may provide an interface that allows the middleware 843, the API 845, or at least one of the applications 847 to access discrete elements of the electronic device 801 so as to control or manage system resources.

The middleware 843 may perform a mediation role such that the API 845 or at least one of the applications 847 communicates with the kernel 841 to exchange data.

The middleware 843 may process task requests received from at least one of the applications 847 according to a priority. For example, the middleware 843 may assign the priority, which makes it possible to use a system resource of the electronic device 801, to at least one of at least one of the applications 847. For example, the middleware 843 may process the one or more task requests according to the priority assigned to the at least one, which enables scheduling or load balancing on the one or more task requests.

The API 845 may be an interface through which at least one of the applications 847 controls a function provided by the kernel 841 or the middleware 843, and may include at least one interface or function for a file control, a window control, image processing, or a character control.

The I/O interface 850 may send an instruction or data, input from a user or another external device, to other element(s) of the electronic device 801. Furthermore, the I/O interface 850 may output an instruction or data, received from other element(s) of the electronic device 801, to a user or another external device.

The display 860 may include a liquid crystal display (LCD), a light-emitting diode (LED) display, an organic LED (OLED) display, a microelectromechanical systems (MEMS) display, or an electronic paper display, for example. The display 860 may display various content such as a text, an image, a video, an icon, and a symbol to a user, may include a touch screen and may receive a touch, gesture, proximity, or hovering input using an electronic pen or a portion of a user's body.

The communication interface 870 may establish communication between the electronic device 801 and an external electronic device such as a first external electronic device 802, a second external electronic device 804, or a server 806. For example, the communication interface 870 may be connected to a network 862 through wireless communication or wired communication to communicate with the external device (e.g., the second external electronic device 804 or the server 806).

The wireless communication may include at least one of long-term evolution (LTE), LTE-advanced (LTE-A), code division multiple access (CDMA), wideband CDMA (WCDMA), universal mobile telecommunications system (UMTS), wireless broadband (WiBro), and global system for mobile communications (GSM), as a cellular communication protocol. Furthermore, the wireless communication may include the local area network 864 such as at least one of a wireless fidelity (Wi-Fi), Bluetooth™, near field communication (NFC), magnetic stripe transmission (MST), and global navigation satellite system (GNSS).

The MST may generate a pulse in response to transmission data using an electromagnetic signal, and the pulse may generate a magnetic field signal. The electronic device 801 may send the magnetic field signal to point of sales (PoS), the PoS may detect the magnetic field signal using an MST reader. The electronic device 801 may recover the data by converting the detected magnetic field signal to an electrical signal.

The GNSS may include at least one of a global positioning system (GPS), a global navigation satellite system (Glonass), Beidou navigation satellite system (Beidou), and Galileo (i.e., the European global satellite-based navigation system) according to an available area or a bandwidth, for example. In this disclosure, “GPS” and “GNSS” may be interchangeably used. The wired communication may include at least one of universal serial bus (USB), high definition multimedia interface (HDMI), a recommended standard-232 (RS-232), and plain old telephone service (POTS). The network 862 may include at least one of telecommunications networks a computer network (e.g., LAN or WAN), the Internet, or a telephone network.

Each of the first and second external electronic devices 802 and 804 may be a device of which the type is different from or the same as that of the electronic device 801. According to an embodiment, the server 806 may include a group of one or more servers. According to embodiments, all or a portion of operations that the electronic device 801 will perform may be executed by another or plural electronic devices (e.g., the electronic devices 802 and 804 and the server 806). When the electronic device 801 executes any function or service automatically or in response to a request, the electronic device 801 may not perform the function or the service internally, but, alternatively additionally, may request at least a portion of a function associated with the electronic device 801 at another device which may execute the requested function or additional function and may send the execution result to the electronic device 801. The electronic device 801 may provide the requested function or service using the received result or may additionally process the received result to provide the requested function or service. To this end, cloud computing, distributed computing, or client-server computing may be used.

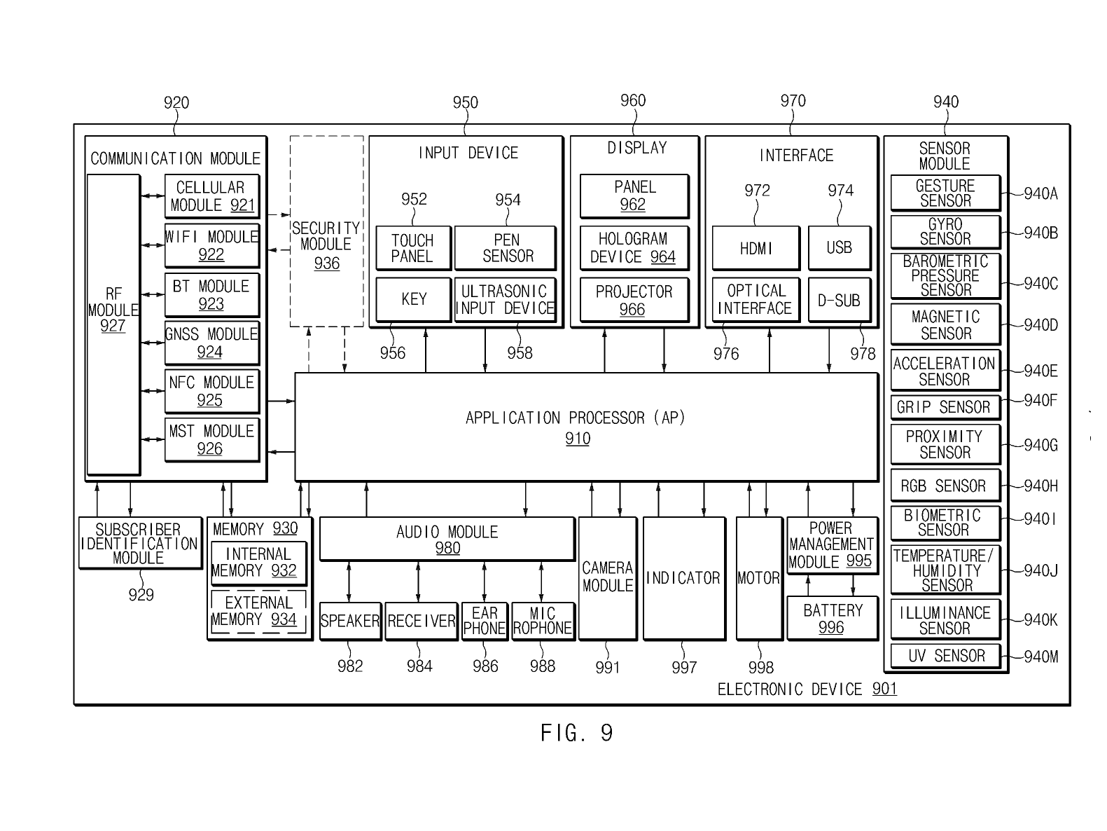

FIG. 9 illustrates a block diagram of an electronic device according to embodiments of the present disclosure.

Referring to FIG. 9, an electronic device 901 FIG. 8. The electronic device 901 may include one or more processors (e.g., an application processor) 910, a communication module 920, a subscriber identification module 929, a memory 930, a sensor module 940, an input device 950, a display 960, an interface 970, an audio module 980, a camera module 991, a power management module 995, a battery 996, an indicator 997, and a motor 998.

The processor 910 may drive an OS or an application to control a plurality of hardware or software elements connected to the processor 910 and may process and compute a variety of data. For example, the processor 910 may be implemented with a system on chip (SoC). According to an embodiment, the processor 910 may further include a graphic processing unit (GPU) and/or an image signal processor. The processor 910 may include at least a part (e.g., a cellular module 921) of elements illustrated in FIG. 9. The processor 910 may load and process an instruction or data, which is received from at least one of other elements (e.g., a nonvolatile memory), and may store a variety of data at a nonvolatile memory.

The communication module 920 may be configured the same as or similar to the communication interface 870 of FIG. 8. The communication module 920 may include the cellular module 921, a Wi-Fi module 922, a Bluetooth module 923, a GNSS module 924 (e.g., a GPS module, a Glonass module, Beidou module, or a Galileo module), a NFC module 925, a MST module 926, and a radio frequency (RF) module 927.

The cellular module 921 may provide voice communication, video communication, a character service, and Internet service through a communication network. According to an embodiment, the cellular module 921 may perform discrimination and authentication of the electronic device 901 within a communication network using the subscriber identification module (SIM) card 929. According to an embodiment, the cellular module 921 may perform at least a portion of functions that the processor 910 provides. According to an embodiment, the cellular module 921 may include a communication processor (CP).

For example, each of the Wi-Fi module 922, the Bluetooth module 923, the GNSS module 924, the NFC module 925, or the MST module 926 may include a processor for processing data exchanged through a corresponding module. According to an embodiment, at least two of the cellular module 921, the Wi-Fi module 922, the BT module 923, the GNSS module 924, the NFC module 925, or the MST module 926 may be included within one integrated circuit (IC) or an IC package.

For example, the RF module 927 may send and receive a communication signal (e.g., an RF signal). For example, the RF module 927 may include a transceiver, a power amplifier module (PAM), a frequency filter, a low noise amplifier (LNA), and an antenna. According to another embodiment, at least one of the cellular module 921, the Wi-Fi module 922, the BT module 923, the GNSS module 924, the NFC module 925, or the MST module 926 may send and receive an RF signal through a separate RF module.

The SIM card 929 may include a card and/or an embedded SIM which includes a subscriber identification module and may include unique identify information (e.g., integrated circuit card identifier (ICCID)) or subscriber information (e.g., integrated mobile subscriber identity (IMSI)).

The memory 930 may include an internal memory 932 or an external memory 934. For example, the internal memory 932 may include at least one of a volatile memory (e.g., a dynamic random access memory (DRAM), a static RAM (SRAM), or a synchronous DRAM (SDRAM)), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, or a NOR flash memory), a hard drive, or a solid state drive (SSD).

The external memory 934 may include a flash drive compact flash (CF), secure digital (SD), micro secure digital (Micro-SD), mini secure digital (Mini-SD), extreme digital (xD), multimedia card (MMC), a memory stick. The external memory 934 may be operatively and/or physically connected to the electronic device 901 through various interfaces.

The security module 936 includes a storage space of which a security level is higher than that of the memory 930 and may be a circuit that guarantees safe data storage and a protected execution environment. The security module 936 may be implemented with a separate circuit and may include a separate processor. For example, the security module 936 may be in a smart chip or an SD card, which is removable, or may include an embedded secure element (eSE) embedded in a fixed chip of the electronic device 901. Furthermore, the security module 936 may operate based on an OS that is different from the OS of the electronic device 901. For example, the security module 936 may operate based on java card open platform (JCOP) OS.

The sensor module 940 may measure a physical quantity or may detect an operation state of the electronic device 901. The sensor module 940 may convert the measured or detected information to an electric signal. The sensor module 940 may include at least one of a gesture sensor 940A, a gyro sensor 940B, a barometric sensor 940C, a magnetic sensor 940D, an acceleration sensor 940E, a grip sensor 940F, a proximity sensor 940G, a color sensor 940H (e.g., red, green, blue (RGB) sensor), a biometric sensor 940I, a temperature/humidity sensor 940J, an illuminance sensor 940K, and an ultraviolet (UV) sensor 940M.

Additionally or alternatively, the sensor module 940 may include an E-nose sensor, an electromyography sensor (EMG) sensor, an electroencephalogram (EEG) sensor, an electrocardiogram (ECG) sensor, an infrared (IR) sensor, an iris sensor, and/or a fingerprint sensor. The sensor module 940 may further include a control circuit for controlling at least one or more sensors included therein. According to an embodiment, the electronic device 901 may further include a processor which is a part of the processor 910 or independent of the processor 910 and is configured to control the sensor module 940. The processor may control the sensor module 940 while the processor 910 remains in a sleep state.

The input device 950 may include a touch panel 952, a (digital) pen sensor 954, a key 956, or an ultrasonic input unit 958. The touch panel 952 may use at least one of capacitive, resistive, infrared, or ultrasonic detecting methods, and may further include a control circuit, and a tactile layer to provide a tactile reaction to a user.

The (digital) pen sensor 954 may be a part of a touch panel or may include an additional sheet for recognition. The key 956 may include a physical button, an optical key, and a keypad. The ultrasonic input device 958 may detect (or sense) an ultrasonic signal, which is generated from an input device, through a microphone 988 and may check data corresponding to the detected ultrasonic signal.

The display 960 may include a panel 962, a hologram device 964, or a projector 966. The panel 962 may be configured the same as or similar to the display 860 of FIG. 8. The panel 962 may be implemented to be flexible, transparent or wearable. The panel 962 and the touch panel 952 may be integrated into a single module. The hologram device 964 may display a stereoscopic image in a space using a light interference phenomenon. The projector 966 may project light onto a screen so as to display an image. The screen may be arranged in the inside or the outside of the electronic device 901. According to an embodiment, the display 960 may further include a control circuit for controlling the panel 962, the hologram device 964, or the projector 966.

The interface 970 may include a high-definition multimedia interface (HDMI) 972, a universal serial bus (USB) 974, an optical interface 976, and a d-subminiature (D-sub) 978. The interface 970 may be included in the communication interface 870 illustrated in FIG. 8. Additionally or alternatively, the interface 970 may include a mobile high-definition link (MHL) interface, an SD card/multi-media card (MMC) interface, or an infrared data association (IrDA) standard interface.

The audio module 980 may convert a sound and an electric signal in dual directions. At least a part of the audio module 980 may be included in the input/output interface 850 illustrated in FIG. 8. The audio module 980 may process sound information that is input or output through a speaker 982, a receiver 984, an earphone 986, or the microphone 988.

The camera module 991 for shooting a still image or a video may include at least one or more image sensors (e.g., a front sensor and a rear sensor), a lens, an image signal processor (ISP), or a flash (e.g., an LED or a xenon lamp).

The power management module 995 may manage power of the electronic device 901. According to an embodiment, a power management integrated circuit (PMIC), a charger IC, or a battery gauge may be included in the power management module 995. The PMIC may have a wired charging method and/or a wireless charging method. The wireless charging method may include a magnetic resonance method, a magnetic induction method or an electromagnetic method and may further include an additional circuit such as a coil loop, a resonant circuit, and a rectifier. The battery gauge may measure a remaining capacity of the battery 996 and a voltage, current or temperature thereof while the battery is charged. The battery 996 may include a rechargeable battery and/or a solar battery.

The indicator 997 may display a specific state of the electronic device 901 or a part thereof, such as a booting, message, or charging state. The motor 998 may convert an electrical signal into a mechanical vibration and may generate the following effects: vibration, haptic. A processing device for supporting a mobile TV may be included in the electronic device 901 and may process media data according to the standards of digital multimedia broadcasting (DMB), digital video broadcasting (DVB), or MediaFlo™.

Each of the above-mentioned elements of the electronic device according to embodiments of this disclosure may be configured with one or more components, and the names of the elements may be changed according to the type of the electronic device. The electronic device according to embodiments may include at least one of the above-mentioned elements, and some elements may be omitted or other additional elements may be added. Some of the elements of the electronic device according to embodiments may be combined with each other so as to form one entity, so that the functions of the elements may be performed in the same manner as before the combination.

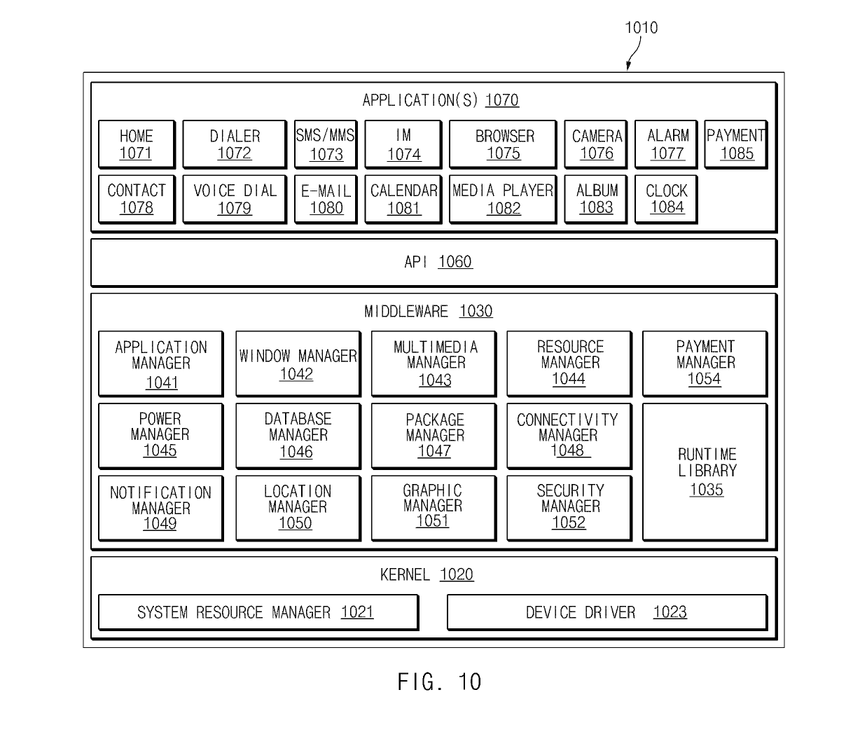

FIG. 10 illustrates a block diagram of a program module according to embodiments of the present disclosure.

In FIG. 10, a program module 1010 may include an OS to control resources associated with an electronic device, and/or diverse applications driven on the OS, such as android, iOS, windows, symbian, tizen, or bada.

The program module 1010 may include a kernel 1020, a middleware 1030, an application programming interface (API) 1060, and/or applications 1070. At least a part of the program module 1010 may be preloaded on an electronic device or may be downloadable from an external electronic device.

The kernel 1020 may include a system resource manager 1021 or a device driver 1023. The system resource manager 1021 may perform control, allocation, or retrieval of system resources. According to an embodiment, the system resource manager 1021 may include a process managing unit, a memory managing unit, or a file system managing unit. The device driver 1023 may include a display driver, a camera driver, a Bluetooth driver, a common memory driver, an USB driver, a keypad driver, a Wi-Fi driver, an audio driver, or an inter-process communication (IPC) driver.

The middleware 1030 may provide a function which at least one of the applications 1070 needs in common or may provide diverse functions to at least one of the applications 1070 through the API 1060 to allow at least one of the applications 1070 to efficiently use limited system resources of the electronic device. According to an embodiment, the middleware 1030 may include at least one of a runtime library 1035, an application manager 1041, a window manager 1042, a multimedia manager 1043, a resource manager 1044, a power manager 1045, a database manager 1046, a package manager 1047, a connectivity manager 1048, a notification manager 1049, a location manager 1050, a graphic manager 1051, a security manager 1052, or a payment manager 1054.

The runtime library 1035 may include a library module which is used by a compiler to add a new function through a programming language while at least one of the applications 1070 is being executed. The runtime library 1035 may perform input/output management, memory management, or capacities about arithmetic functions.

The application manager 1041 may manage a life cycle of at least one application of at least one of the applications 1070. The window manager 1042 may manage a GUI resource which is used in a screen. The multimedia manager 1043 may identify a format necessary for playing diverse media files and may perform encoding or decoding of media files by using a codec suitable for the format. The resource manager 1044 may manage resources such as a storage space, memory, or source code of at least one application of at least one of the applications 1070.

The power manager 1045 may operate with a basic input/output system (BIOS) to manage a battery or power and may provide power information for an operation of an electronic device. The database manager 1046 may generate, search for, or modify database which is to be used in at least one application of at least one of the applications 1070. The package manager 1047 may install or update an application which is distributed in the form of a package file.

The connectivity manager 1048 may manage wireless connection such as Wi-Fi or Bluetooth. The notification manager 1049 may display or notify an event such as arrival message, appointment, or proximity notification in a mode that does not disturb a user. The location manager 1050 may manage location information about an electronic device. The graphic manager 1051 may manage a graphic effect that is provided to a user or a user interface relevant thereto. The security manager 1052 may provide a general security function necessary for system security or user authentication. According to an embodiment, when an electronic device includes a telephony function, the middleware 1030 may further includes a telephony manager for managing a voice or video call function of the electronic device.

The middleware 1030 may include a middleware module that combines diverse functions of the above-described elements. The middleware 1030 may provide a module specialized to each OS type to provide differentiated functions. Additionally, the middleware 1030 may dynamically remove a part of the preexisting elements or may add new element(s) thereto.

The API 1060 may be a set of programming functions and may be provided with a configuration which is variable depending on an OS. For example, when an OS is android or iOS, it may be permissible to provide one API set per platform. When the OS is tizen, it may be permissible to provide two or more API sets per platform.

The applications 1070 may provide functions for a home 1071, a dialer 1072, an SMS/MMS 1073, an instant message (IM) 1074, a browser 1075, a camera 1076, an alarm 1077, a contact 1078, a voice dial 1079, an e-mail 1080, a calendar 1081, a media player 1082, an album 1083, a timepiece 1084, or a payment 1085, or for offering health care (e.g., measuring an exercise quantity or blood sugar levels) or environment information (e.g., atmospheric pressure, humidity, or temperature).

According to an embodiment, at least one of the applications 1070 may include an information exchanging application to support information exchange between the electronic device 801 and an external electronic device 802 or 804. The information exchanging application may include a notification relay application for sending specific information to the external electronic device or a device management application for managing the external electronic device.

For example, the notification relay application may include a function of sending notification information, which arise from other applications r SMS/MMS, e-mail, health care, or environmental information, for example), to an external electronic device 802 or 804. Additionally, the notification relay application may receive notification information from an external electronic device and provide the notification information to a user.

The device management application may manage install, delete, or update at least one function (e.g., turn-on/turn-off of an external electronic device or adjustment of brightness of the external electronic 802 or 804) which communicates with the electronic device, an application running in the external electronic device, or a call service or a message service provided from the external electronic device.

According to an embodiment, at least one of the applications 1070 may be assigned in accordance with an attribute of the external electronic device 802 or 804. At least one of the applications 1070 may be received from an external electronic device such as the server 806 or the electronic device 802 or 804. At least one of the applications 1070 may include a preloaded application or a third party application which is downloadable from a server. The element titles of the program module 1010 according to the embodiment may be modifiable depending on types of operating systems.

According to embodiments, at least a part of the program module 1010 may be implemented by software, firmware, hardware, or a combination of two or more thereof. At least a portion of the program module 1010 may be executed by the processor 910. At least a portion of the program module 1010 may include modules, programs, routines, sets of instructions, or processes for performing one or more functions.

The term “module” used herein may represent a unit including one or more combinations of hardware, software and firmware. The term “module” may be interchangeably used with the terms “unit”, “logic”, “logical block”, “component”, or “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific IC (ASIC) chip, a field-programmable gate array (FPGA), and a programmable-logic device for performing some operations, which are known or will be developed in the future.

At least a part of an apparatus (e.g., modules or functions thereof) or a method (e.g., operations) according to embodiments may be implemented by instructions stored in a computer-readable storage media in the form of a program module. The instruction, when executed by a processor, may cause the one or more processors to perform a function corresponding to the instruction. The computer-readable storage media may be the memory 830.

A computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk), and hardware devices (e.g., a read only memory (ROM), a random access memory (RAM), or a flash memory). A program instruction may include not only a mechanical code such as information generated by a compiler but also a high-level language code executable on a computer using an interpreter. The above-described hardware unit may be configured to operate via one or more software modules for performing an operation of embodiments, and vice versa.

A module or a program module according to embodiments may include at least one of the above elements, or a part of the above elements may be omitted, or additional other elements may be further included. Operations performed by a module, a program module, or other elements according to embodiments may be executed sequentially, in parallel, repeatedly, or in a heuristic method. In addition, a part of operations may be executed in different sequences or may be omitted. Alternatively, other operations may be added.

According to embodiments of this disclosure, a bookmark function may be provided without generating a separate file by applying metadata included in a video file. Accordingly, it may be possible to reduce the capacity of the computing/storage resources consumed to generate the separate bookmark file.

Furthermore, according to embodiments of the present disclosure, since metadata included in a video file includes bookmark information, bookmark information may be shared when the video file is shared.

A variety of effects directly or indirectly understood through this disclosure may be provided.

While the present disclosure has been shown and described with reference to embodiments thereof, it will be understood by those skilled in the art that various changes in form and details may be made therein without departing from the spirit and scope of this disclosure as defined by the appended claims and their equivalents.

What is claimed is:

1. An electronic device comprising:
a display;
a memory that stores a video file which comprises video data and metadata; and
a processor operatively connected with the display and the memory,
wherein the metadata comprises information about a specified playback time point or a specified playback time interval among a total playback time of the video data, and
wherein, the memory stores instructions that, when executed, cause the processor to output, on the display, a first preview associated with the total playback time of the video data and a second preview associated with the specified playback time point or the specified playback time interval.

2. The electronic device of claim 1, wherein if the first preview is selected, the memory further stores instructions that, when executed, causes the processor to play the video data from a predefined playback time point.

3. The electronic device of claim 2, wherein the predefined playback time point comprises a first playback time point of the video data or a playback time point at which the playback of the video data was previously ended.

4. The electronic device of claim 1, wherein if the second preview is selected, the memory further stores instructions that, when executed, cause the processor to play the video data from the specified playback time point or a starting time point of the specified playback time interval.

5. The electronic device of claim 1, further comprising:
a cache memory operatively connected with the processor,
wherein data associated with the first preview or the second preview is stored in the cache memory.

6. The electronic device of claim 1, wherein each of the first preview and the second preview comprises an image object or a video object.

7. The electronic device of claim 6, wherein the image object or the video object of the first preview is extracted from at least a portion of the total playback time of the video data.

8. The electronic device of claim 6, wherein the image object or the video object of the second preview is extracted from the specified playback time point of the video data or at least a portion of the specified playback time interval of the video data.

9. The electronic device of claim 1, wherein the memory further stores instructions that, when executed, cause the processor to generate a video file corresponding to the specified playback time point or the specified playback time interval based on the video data.

10. The electronic device of claim 9, further comprising:
a communication circuit that establishes a communication with an external device,
wherein the memory further stores instructions that, when executed, cause the processor to send the generated video file to the external device through the communication circuit.

11. An electronic device comprising:
a memory that stores media data; and
a processor that:
plays the media data through a display operatively connected with the electronic device;
obtains an input while the media data is played;
generates bookmark information corresponding to at least a portion of the media data based at least on the input; and
includes the bookmark information in the media data.

12. The electronic device of claim 11, wherein the processor further includes the bookmark information in the media data as at least a portion of the media data and stores the media data comprising the bookmark information in the memory.

13. The electronic device of claim 11, wherein the processor further outputs, on the display, an object of at least the portion of the media data corresponding to the bookmark information.

14. The electronic device of claim 13, wherein the processor further:
outputs, on the display, the object corresponding to the bookmark information as a first-type object by using at least a portion of at least the portion of the media data if a playback time point of at least the portion of the media data corresponding to the bookmark information belongs to a first specified range; and
outputs, on the display, the object corresponding to the bookmark information as a second-type object by using at least part of at least the portion of the media data if the playback time point of at least the portion of the media data corresponding to the bookmark information belongs to a second specified range.

15. The electronic device of claim 11, wherein the processor further generates a preview video corresponding to at least the portion of the media data based on at least a portion of the bookmark information.

16. The electronic device of claim 11, wherein at least the portion of the media data comprises first media data corresponding to a first range and second media data corresponding to a second range lagging behind the first range,
wherein the bookmark information comprises first bookmark information corresponding to the first media data and second bookmark information corresponding to the second media data, and
wherein the processor further:
assigns a first priority to the first bookmark information; and
assigns a second priority to the second bookmark information.

17. The electronic device of claim 16, wherein the processor further outputs the second media data before the first media data on the display based at least in part on the first priority or the second priority.

18. The electronic device of claim 11, wherein the processor further displays, on the display, first media data corresponding to first bookmark information and second media data corresponding to second bookmark information, based at least on the first bookmark information corresponding to at least the portion of the media data and the second bookmark information corresponding to at least a portion of other media data.

19. The electronic device of claim 11, wherein the processor further generates the bookmark information based at least on a playback history of the media data or any other media data.

20. The electronic device of claim 11, wherein the bookmark information comprises playback speed information about at least the portion of the media data.
